(19) United States
(12) Patent Application Publication
(10) Pub. No.: US 2008/0137187 A1
(43) Pub. Date: Jun. 12, 2008

(54) Polarizing Plate, Method for Produce Thereof, Optical Film, and Image Display Therewith

(75) Inventors: Kanji Nishida, Osaka (JP); Ryouichi Takamura, Osaka (JP); Hiroaki Kobayashi, Osaka (JP); Tomoaki Masuda, Osaka (JP); Yutaka Fujita, Osaka (JP); Naoki Tomoguchi, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Nitto Denko Corporation, Ibaraki-shi, Osaka (JP)

(21) Appl. No.: 11/795,295

(22) PCT Filed: Jan. 16, 2006
(86) PCT No.: PCT/JP06/00432

§ 371 Date: Jul. 16, 2007

(30) Foreign Application Priority Data
Jan. 17, 2005 (JP) 2005-008858

(51) Int. Cl. G02B 5/30; C03C 27/00

(52) U.S. Cl. 359/485; 156/99

(57) ABSTRACT

A polarizing plate of the invention comprises a polarizing film; and a protective film bonded to one or both sides of the polarizing film with an adhesive layer or a pressure-sensitive adhesive layer interposed therebetween, wherein the adhesive layer or the pressure-sensitive adhesive layer has a thickness of 52 nm or less. Demand of in-plane uniformity of the polarizing plate is becoming severe due to recent size increase and image quality improvement of liquid crystal display. The polarizing plate has less stripe-like irregularities and good in-plane uniformity.

### TECHNICAL FIELD

The invention relates to a polarizing plate for use in image displays such as liquid crystal displays (LCDs) and electroluminescence displays (ELDs) and to a method for produce thereof. The invention also relates to an optical film including the polarizing plate and to an image display including the polarizing plate or the optical film.

### BACKGROUND ART

Polarizing plates for use in image displays are required to have both high transmittance and high degree of polarization in order to create bright images with good color reproducibility. Such polarizing plates are generally produced by a process including dying a polyvinyl alcohol (PVA) film with a dichroic material such as iodine and dichroic dyes to form a polarizing film then bonding a protective film made of a polymer film such as a triacetylcellulose film to both sides of the polarizing film.

Such polarizing plates are required to have not only good optical properties such as good transmittance, polarization degree and hue but also even image displaying characteristics, specifically high in-plane uniformity. Concerning the in-plane uniformity, there have been disclosed techniques for increasing the in-plane uniformity of polarizing plates, which include reducing unevenness of polarizing films (for example, see Patent Literature 1 below) and reducing unevenness of protective films (for example, see Patent Literature 2 below). However, as image displays increase in size and image quality in recent years, requirements for the in-plane uniformity of polarizing plates become severe, and there is encountered unevenness in new modes such as stripe-like irregularities (striped unevenness) visible as light and dark reflection of light. Thus, satisfactory uniformity has not been obtained yet. The striped unevenness is formed at a substantially central potion of polarizing plates in a direction the same as the MD direction (flow direction).

Patent Literature 1: Japanese Patent Application Laid-Open (JP-A) No. 2001-290025

Patent Literature 2: JP-A No. 2002-221620

### DISCLOSURE OF INVENTION

### Problems to be Solved by the Invention

In light of the problems described above, an object of the invention is to provide a polarizing plate that includes a polarizing film and a protective film bonded to one or both sides of the polarizing film with an adhesive layer or a pressure-sensitive adhesive layer interposed therebetween and has less stripe-like irregularities and good in-plane uniformity and to provide a method for produce thereof. Another object of the invention is to provide an optical film including the polarizing plate and at least one optically functional layer laminated thereon and to provide an image display including the polarizing plate or the optical film.

### Means for Solving the Problems

As a result of active investigations for solving the above problems, the inventors have found that the objects can be achieved with the polarizing plate and the method for produced thereof described below, and have completed the invention.

The present invention relates to a polarizing plate, comprising: a polarizing film; and a protective film bonded to one or both sides of the polarizing film with an adhesive layer or a pressure-sensitive adhesive layer interposed therebetween, wherein the adhesive layer or the pressure-sensitive adhesive layer has a thickness of 52 nm or less; and the polarizing film preferably has a moisture percentage of 15 to 26% by weight when the bonding is performed to produce the polarizing plate film.

A method for producing a polarizing plate of the invention is characterized by that comprising: bonding a protective film to one or both sides of a polarizing film with an adhesive or a pressure-sensitive adhesive; and then drying them by heating, wherein the adhesive or the pressure-sensitive adhesive is laminated such that an adhesive layer or a pressure-sensitive adhesive layer having a thickness of 52 nm or less is formed after the drying. In the method, the polarizing film preferably has a controlled moisture percentage of 15 to 26% by weight when the protective film is bonded to one or both sides of the polarizing film with the adhesive or the pressure-sensitive adhesive.

The invention also relates to an optical film, comprising: the polarizing plate or the polarizing plate produced by the above method; and at least one optically functional layer laminated on the polarizing plate, also relates to an image display comprising the polarizing plate or the optical film.

### EFFECTS OF THE INVENTION

As stated above, the polarizing plate of the invention includes a polarizing film and a protective film bonded to one or both sides of the polarizing film with an adhesive layer or a pressure-sensitive adhesive layer interposed therebetween, wherein the adhesive layer or the pressure-sensitive adhesive layer is characterized by a thickness of 52 nm or less. Even when used in image displays, such a polarizing plate has less stripe-like visible irregularities and thus can provide a polarizing plate with high in-plane uniformity. If this polarizing plate is used, image displays with high resolution and high contrast can be achieved.

### BEST MODE FOR CARRYING OUT THE INVENTION

The polarizing plate of the invention includes a polarizing film and a protective film bonded to one or both sides of the polarizing film with an adhesive layer or a pressure-sensitive adhesive layer 52 nm or less in thickness interposed therebetween. The adhesive layer or the pressure-sensitive adhesive layer may be made of an adhesive or a pressure-sensitive adhesive without particular limitation. Since a reduction in weight or thickness can be easier for an adhesive layer than for a pressure-sensitive adhesive, an adhesive is preferably used. In general, such an adhesive or a pressure-sensitive adhesive may be applied to one or both sides of the polarizing film or the protective film, and then the polarizing film and the protective film may be laminated. After drying, the laminate of the polarizing film, the adhesive layer or the pressure-sensitive adhesive layer and the protective film results in a polarizing plate.

If the adhesive layer or the pressure-sensitive adhesive layer of the polarizing plate has a thickness of 52 nm or less after drying, the advantages of the invention can be obtained. In particular, the thickness is preferably 35 nm or less, more preferably 29 nm or less. If the thickness is too thick, it will be difficult to maintain the in-plane uniformity of the adhesive layer or the pressure-sensitive adhesive layer, so that stripe-like irregularities can occur, and thus the advantages of the invention cannot be obtained. The minimum thickness of the adhesive layer or the pressure-sensitive adhesive layer is preferably, but not limited to, 5 nm or more, more preferably 10 nm or more, depending on the type of the adhesive layer or the pressure-sensitive adhesive layer. If the adhesive layer or the pressure-sensitive adhesive layer is too thin, it will be difficult to obtain the minimum adhesive force necessary for the polarizing plate, and additional defects in appearance can easily occur.

While any adhesive and any bonding method may be used to form the adhesive layer, a vinyl polymer-containing adhesive or the like may be typically used. The adhesive layer comprising such an adhesive may be formed as a dried layer of an aqueous coating solution. In the preparation of the aqueous solution, if necessary, a crosslinking agent or any other additive and a catalyst such as an acid may be added. The vinyl polymer in the adhesive is preferably a polyvinyl alcohol resin. The polyvinyl alcohol resin may also be added a water-soluble crosslinking agent such as a boric acid or borax, glutar aldehyde or melamine, and oxalic acid. Particularly where a polyvinyl alcohol-based polymer film is used as the polarizing film, a polyvinyl alcohol resin-containing adhesive is preferably used in terms of adhesion properties. An adhesive that contains a polyvinyl alcohol resin having an acetoacetyl group is more preferred in terms of improving durability.

While the polyvinyl alcohol resin may be of any type, a polyvinyl alcohol resin with an average degree of polymerization of about 100 to about 3000 and an average degree of saponification of about 85 to about 100% by mole is preferably used in terms of adhesion properties. The concentration of the aqueous adhesive solution is determined according to the thickness of the adhesive layer, the concentration is preferably, but not limited to, from 0.1 to 15% by weight, more preferably from 0.5 to 10% by weight, because the adhesive. If the concentration of the solution is too high, its viscosity can be too high so that stripe-like irregularities may be easily formed. If the concentration of the solution is too low, the coatability may be poor so that unevenness can be easily formed.

Examples of polyvinyl alcohol-based resin include: a polyvinyl alcohol obtained by saponifying a polyvinyl acetate; a derivative thereof; a saponified copolymer of vinyl acetate and a monomer copolymerizable therewith; and polyvinyl alcohols modified by acetalization, urethanization, etherification, grafting, phosphate esterification and the like. Examples of the monomers include, unsaturated carboxylic acids such as maleic anhydride, fumaric acid, crotonic acid, itaconic acid and (meth) acrylic acid, and esters thereof; α-olefins such as ethylene and propylene; (meth)allylsulfonic acid or sodium salt thereof, (meth)allylsulfonate; sodium sulfonate (monoalkyl maleate), sodium disulfonate (alkyl maleate); N-methylolacrylamide; an alkai salt of acrylamide alkylsulfonate; N-vinylpyrrolidone, a derivative of N-vinylpyrrolidone and the like. The polyvinyl alcohol-based resins can be either used alone or in combination of two kinds or more.

A polyvinyl alcohol-based resin having an acetoacetyl group is obtained by reacting a polyvinyl alcohol-based resin and diketene to each other with a known method. Examples of known methods include: a method in which a polyvinyl alcohol-based resin is dispersed into a solvent such as acetic acid, to which diketene is added and a method in which a polyvinyl alcohol-based resin is previously dissolved into a solvent such as dimethylformamide or dioxane, to which diketene is added. Another example is a method in which diketene gas or diketene liquid is brought into direct contact with a polyvinyl alcohol.

No specific limitation is imposed on a degree of modification by an acetoacetyl group in a polyvinyl alcohol-based resin having an acetoacetyl group or groups as far as the degree of modification is 0.1 mol % or more. If the degree of modification is less than 0.1 mol %, water resistance of an adhesive layer is insufficient, which is improper. A degree of modification by an acetoacetyl group is preferably from about 0.1 to about 40 mol %, more preferably from 1 to 20 mol %, further preferably from 2 to 7 mol %. If a degree of modification by an acetoacetyl group exceeds 40 mol %, reaction sites with a crosslinking agent is fewer to thereby reduce an effect of improvement on moisture resistance and heat resistance. The degree of modification by an acetoacetyl group can be measured with NMR (Nuclear Magnetic Resonance).

Any of crosslinking agents that have been generally used for adhesives can be used without a specific limitation thereon. In a case the adhesive using the above a polyvinyl alcohol-based resin, a crosslinking agent that has at least two functional groups having reactivity with the polyvinyl alcohol-based resin is preferably used. Examples thereof include: alkylene diamines having an alkylene group and two amino groups such as ethylene diamine, triethylene diamine and hexamethylene diamine; isocyanates such as tolylene diisocyanate, hydrogenated tolylene diisocyanate, trimethylolpropane tolylene diisocyanate adduct, triphenylmethane triisocyanate, methylenebis(4-phenylmethane) triisocyanate and isophorone diisocyanate, and ketoxime-blocked products thereof or isocyanates of phenol-blocked products; epoxy compounds such as ethylene glycol diglycidyl ether, polyethylene glycol diglycidyl ether, glycerin di- or triglicydyl ether, 1,6-hexanediol diglycidyl ether, trimethylolpropane triglycidyl ether, diglicidyl aniline and diglycidyl amine; monoaldehydes such as formaldehyde, acetaldehyde, propionaldehyde and butylaldehyde; dialdehydes such as glyoxal, malonaldehyde, succindialdehyde, glutardialdehyde, maleic dialdehyde and phthaldialdehyde; amino-formaldehyde resins such as condensates with formaldehyde of methylolurea, methylolmelamine, alkylated methylolurea, alkylated methylolmelamine, acetoguanamine and benzoguanamine; salts of divalent metals or trivalent metals such as sodium, potassium, magnesium, calcium, aluminum, iron and nickel, and oxides of the metals. Preferable among the crosslinking agents are amino-formaldehyde resins, especially a compound having a methylol group.

The amount of the crosslinking agent is generally about 0.1 to about 35 parts by weight, preferably 10 to 25 parts by weight, based on 100 parts by weight of the resin. When importance is attached to the durability of the adhesive, the crosslinking agent may be effectively added in an amount of 30 to 46 parts by weight, more preferably of 32 to 40 parts by weight, in return for the fact that the time period from the preparation of the adhesive to the formation of the adhesive layer (pot life) is shortened.

Note that various additives described below can be further mixed into the adhesive layer or the pressure-sensitive adhesive layer, coupling agents such as a silane coupling agent and a titanium coupling agent; various kinds of tackifiers; an ultraviolet absorbent; an antioxidant; stabilizers such as a heat resistance stabilizer and a hydrolysis resistance stabilizer; and the like.

There is no particular limitation to specifications of the polarizing film, the protective film, and the adhesive layer or the pressure-sensitive adhesive layer, such as the number of the layers, as long as the polarizing plate can be formed by bonding the protective film to one or both sides of the polarizing film with the adhesive layer or the pressure-sensitive adhesive layer interposed therebetween. An under coat layer, an adhesion facilitating layer or the like may be provided between the adhesive layer or the pressure-sensitive adhesive layer and the protective film or the polarizing film.

Any appropriate known method may be used to bond the polarizing film and the protective film with the adhesive layer or the pressure-sensitive adhesive layer interposed therebetween without particular limitation. In a method, for example, they are accompanied with an adhesive (solution) or pressure-sensitive adhesive (solution) with a controlled concentration or viscosity and allowed to pass between a pair of a first roll and a second roll to be compressed. In particular, the invention is characterized in that the adhesive layer or the pressure-sensitive adhesive layer is unusually thin. Thus, the concentration of the adhesive or pressure-sensitive adhesive solution may be controlled, and the distance between rolls for compressing, the roll material, the roll diameter, the convey rate for the lamination, or the like can be controlled as needed, so that the pressure on the adhesive layer or the pressure-sensitive adhesive layer can be controlled, and as a result, the thickness of the adhesive layer or the pressure-sensitive adhesive layer in the polarizing plate can be controlled. For example, important techniques for the formation of such a thin adhesive layer or pressure-sensitive adhesive layer include reducing the concentration (base concentration) of the adhesive solution or the pressure-sensitive adhesive solution and reducing the distance between the rolls for compressing and also include controlling factors such as using a hard material for the rolls and using a relatively small diameter for the rolls.

In the roll coating, a metal roll is preferably used as the first roll, and an elastic roll comprising a metallic core coated with a rubber layer or a resin layer is preferably used as the second roll. The elastic roll as the second roll can control the thickness of the adhesive layer or the pressure-sensitive 30 adhesive layer to 52 nm or less and prevent the generation of stripe-like irregularities on the polarizing plate by the elastic force of the rubber or resin layer.

It is known that when one of a pair of rolls for roll coating is an elastic roll having an elastic layer, the gap (H) between the rolls may be expressed by the following formula: H=2×(μV)^{1/2}(LR/E)^{1/3}(1/W)^{1/6}, wherein μ is the viscosity of the coating liquid, V is the coating speed, L is the thickness of the elastic layer, E is the hardness of the elastic layer, R is the roll diameter, and W is the lamination pressure (see, Chemical Engineering Science Vol. 43, No. 10, pp. 2673-2684 (1988)). In a technique according to the invention, the gap (H) formula is taken into account and used for the design of the adhesive layer or the pressure-sensitive adhesive layer between the polarizing film and the protective film in the production of the polarizing plate, so that the thickness of the adhesive layer or the pressure-sensitive adhesive layer is controlled to be 52 nm or less, and the conditions are examined in the production of the polarizing plate.

A metal roll is preferably used as the first roll. The metal roll to be used has a surface hardness higher than that of the second roll. Examples of the material for the metal roll include iron, stainless steel, titanium, and aluminum. The metal roll is preferably an iron roll in view of cost effectiveness.

For example, the second roll to be used is preferably an elastic roll comprising a metallic core coated with a rubber layer or a resin layer. The hardness of the rubber or resin layer to be used is preferably 60 or more, more preferably 80 or more. In order to prevent scratches on the film surface, the hardness is preferably 90 or less. In this regard, for example, the hardness may be measured with a commercially available durometer (type A) by the method according to JIS K 6253 (1997).

Concerning the diameter of the first and second rolls, the smaller the diameter, the smaller the area in contact with the film, and the higher the pressure applied to the film surface will be. Thus, the diameter of the roll to be used is preferably 250 mm or less, more preferably 200 mm or less, still more preferably 150 mm or less. If the diameter is too small, however, the roll can have low durability so that sufficient force cannot be applied. Thus, a roll with a diameter of 30 mm or more is preferably used, and a roll with a diameter of 70 mm or more is more preferably used.

In the lamination process, the higher convey rate tends to lead to the thicker adhesive layer or pressure-sensitive adhesive layer. While there is no particular limitation to the convey rate, it is preferred that the convey rate is generally controlled to be from about 2 m/minute to about 50 m/minute.

The lamination pressure applied to the adhesive layer or the pressure-sensitive adhesive layer in the lamination process is not particularly limited and may be set as appropriate. In view of easiness of control and in view of the productivity of the polarizing plate, the lamination pressure is preferably from about 0.2 to about 1 MPa, more preferably from about 0.2 to about 0.6 MPa. The lamination pressure may be determined by a measurement process including using pressure sensitive paper (Prescale (ultra super-low pressure, LLLW) produced by Fujifilm Corporation), binarizing the change in the color of the pressure sensitive paper by computer image processing, and determining the lamination pressure from an approximate expression of a pressure standard line produced with respect to the coloring area and concentration.

In the lamination process, a dry lamination method is preferably used, which allows solvent-free lamination or low solvent lamination with an adhesive or pressure-sensitive adhesive. The dry lamination method may use any known dry lamination adhesive and any known lamination technique. It has been found that if this method is used in combination with the essential feature of the invention, stripe-like irregularities can be more effectively reduced.

Examples of the dry lamination adhesive include two-part curable adhesives, two-part solvent-type adhesives, and one-part solvent-free adhesives. The two-part curable adhesives may be acrylic resin-based. The two-part solvent-type adhesives may be polyester-based, aromatic polyester-based, aliphatic polyester-based, polyester/polyurethane-based, polyether/polyurethane-based, or any other resin-based. The one-part solvent-free adhesives (moisture curing type) may be polyether/polyurethane-based or any other resin-based.

There is no particular limitation to the moisture percentage of the polarizing film in the process of bonding the polarizing film to the protective film. However, if the moisture percentage is too low, the resulting polarizing plate can tend to have stripe-like irregularities, and on the other hand if the moisture percentage is too high, durability, adhesive strength or the thickness of the adhesive layer or the pressure-sensitive adhesive layer can be difficult to control. Thus, the moisture percentage of the polarizing film in the process of bonding the protective film to the polarizing film according to the invention is preferably from 15 to 26% by weight, more preferably from 19 to 25% by weight, still more preferably from 22 to 25% by weight. The moisture percentage of the polarizing film is generally adjusted by controlling the drying conditions in the process of producing the polarizing film. If necessary, however, a moisture control process may be separately performed, in which immersion into a water bath, spray of water drop, or repeated drying by heating or under reduced pressure may be performed. PVA polarizing films prepared by wet method with no moisture control generally have a moisture percentage of about 26 to about 33% by weight, depending on the drying process conditions. Thus, such films may be dried by heating at a temperature of about 30 to about 50° C. for a time period of about 60 to about 180 seconds so that the above moisture percentage can be obtained.

The polarizing film to be used is generally a uniaxially-stretched polymer film, such as a uniaxially-stretched polyvinyl alcohol (PVA) film, dyed with a dichroic material such as iodine and a dichroic dye. The thickness of such a polarizing film to be used is preferably, but not limited to, from about 5 to about 80 μm, particularly preferably 40 μm or less. If the thickness of the polarizing film is thin, stripe-like irregularities can tend to be more visible. Therefore, polarizing films with a thickness of 40 μm or less is preferably used, and particularly when the polarizing film has a thickness of 25 μm or less, the effects of the invention can be remarkable.

Concerning the optical properties of the polarizing film, the single-piece transmittance measured with respect to a single piece of the polarizing film is preferably 43% or more, more preferably in the range of 43.3 to 45.0%. The crossed transmittance may be measured by a process including the steps of providing two pieces of the polarizing films, overlaying the two pieces of polarizing films such that their absorption axes make an angle of 90° with each other, and measuring the transmittance of the overlaid films. The crossed transmittance is preferably as small as possible, and practically, it is preferably from 0.00% to 0.050%, more preferably 0.030% or less. In practice, its degree of polarization is preferably from 99.90% to 100%, particularly preferably from 99.93% to 100%. It is preferred that the polarizing film should also have substantially the same optical properties as the above even when measured in the form of a polarizing plate.

Various types of polymer films may be used to form the polarizing film without particular limitations. Examples of such polymer films include polyvinyl alcohol (PVA) films, polyethylene terephthalate (PET) films, ethylene-vinyl acetate copolymer films, partially saponified films thereof, hydrophilic polymer films such as cellulose films, and oriented polyene films such as dehydrated products of PVA and dehydrochlorinated products of polyvinyl chloride. In particular, PVA films are preferably used, because they have good dyeing with a dichroic material such as iodine.

The polymer for use as the material for the polymer film generally has a degree of polarization of 500 to 10,000, preferably of 100 to 6,000, more preferably of 1,400 to 4,000. Where a saponified film is used, its degree of saponification is preferably 75% by mole or more, more preferably 98% by mole or more, still more preferably from 98.3 to 99.8% by mole, for example, in terms of solubility in water.

Where a PVA film is used as the polymer film, a product prepared by any PVA film forming method such as a flow casting method in which an aqueous or organic solvent solution of raw materials is cast to form a film, a casting method, and an extrusion method may be appropriately used. In this case, the film to be used preferably has a retardation of 5 nm to 100 nm. In order to form a polarizing film with in-plane uniformity, variations in the in-plane retardation of the PVA film is preferably as small as possible and preferably 10 nm or less, more preferably 5 nm or less, at a measurement wavelength of 1,000 nm.

General methods for producing the polarizing film may fall roughly into, but are not limited to, a method using dry stretching and a method using wet stretching. While the steps for producing the polarizing film by wet stretching may use any appropriate method depending on the conditions, for example, a method of producing it by a series of producing steps including swelling, dyeing, crosslinking, stretching, water-washing, and drying a polymer film is generally used. Except for the drying step, each step may be performed while the film is immersed in a bath including various kinds of solutions. Concerning the steps of swelling, dyeing, crosslinking, stretching, washing with water, and drying, there is no particular limitation on the order of the steps, the number of times of each step, or the presence or absence of each step, and some steps may be simultaneously performed in a single process, or some steps may be omitted. For example, the stretching may be performed after the dyeing or simultaneously with the swelling or the dyeing or may be followed by the dyeing. A method in which the crosslinking is performed before or after the stretching may also be used. Any appropriate technique may be used for the stretching without limitations. In the case of roll stretching, for example, a method in which stretching is achieved through a difference between the peripheral speeds of rolls provided along the film stretching direction may be used. In each step, an additive such as boric acid, borax or potassium iodide may be added as needed. Thus, if necessary, the polarizing film may contain boric acid, zinc sulfate, zinc chloride, potassium iodide, or the like. In some of these processes, stretching may be performed in the flow direction or in the width direction, as needed, and the process of washing with water may be performed at every process.

For example, the swelling step includes immersing the polymer film in a treatment bath (a swelling bath) filled with water. In this step, the polymer film is washed with water so that the surface of the polymer film can be cleaned of dirt or an anti-blocking agent, and the polymer film is allowed to swell so that it can be expected that the non-uniform state of the film such as unevenness will be effectively alleviated. Glycerin, potassium iodide or the like may be added to the swelling bath as needed. Concerning the concentration of the additive, glycerin is preferably added at a concentration of 5% by weight or less, and potassium iodide is preferably added at a concentration of 10% by weight or less. The temperature of the swelling bath may be from about 20 to about 45° C., and the time period of immersion in the swelling bath may be from about 2 to about 180 seconds. The polymer film may be stretched in the swelling bath, and in such a process, the stretch ratio is from about 1.1 to about 3.5 times.

For example, the dyeing step may include a method of dyeing the polymer film by immersing it in a treatment bath (a dyeing bath) containing a dichroic material such as iodine. Any known conventional dichroic material such as iodine and a organic dye may be used. Examples of applicable organic dyes include Red BR, Red LR, Red R, Pink LB, Rubin BL, Bordeaux GS, Sky Blue LG, Lemon Yellow, Blue BR, Blue 2R, Navy RY, Green LG, Violet LB, Violet B, Black H, Black B, Black GSP, Yellow 3G, Yellow R, Orange LR, Orange 3R, Scarlet GL, Scarlet KGL, Congo Red, Brilliant Violet BK, Supra Blue G, Supra Blue GL, Supra Orange GL, Direct Sky Blue, Direct Fast Orange S, and Fast Black. One or more of these dichroic materials may be used alone or in any combination. Particularly in the invention, iodine is preferably used, because it has good optical properties such as polarization degree and can easily produce a durability-enhancing effect according to the invention.

A solution of the dichroic material in a solvent may be used for the dyeing bath solution. While water such as pure water is generally used as the solvent, an organic solvent compatible with water may further be added. The concentration of the dichroic material is from about 0.010 to about 10% by weight. The time period of the immersion of the polymer film in the dyeing bath may be, but not limited to, about 0.5 to about 20 minutes, and the dyeing bath temperature may be from about 5 to about 42° C. The polymer film may be stretched in the dyeing bath, and the total stretch ratio added up together with the stretch ratios in the previous process may be from about 1.1 to about 3.5 times.

Where iodine is used as the dichroic material, an iodide is preferably further added to the dyeing bath, because it can further improve the dyeing efficiency. Examples of the iodide include potassium iodide, lithium iodide, sodium iodide, zinc iodide, aluminum iodide, lead iodide, copper iodide, barium iodide, calcium iodide, tin iodide, and titanium iodide. The content of any of these iodides in the dyeing bath may be from about 0.010 to about 10% by weight. In particular, potassium iodide is preferably added, and the ratio (weight ratio) of iodine to potassium iodide is preferably in the range of 1:5 to 1:100. For the purpose of improving the in-plane uniformity of the film, a crosslinking agent such as a boron compound may be added as needed.

Besides the method of immersing in the dyeing bath as mentioned above, for example, the dyeing process may be a method of applying or spraying a dichroic material-containing aqueous solution onto the polymer film or a method of premixing a dichroic material in the process of forming the polymer film.

In the crosslinking step, for example, the polymer film is immersed in a treatment bath (a crosslinking bath) containing a crosslinking agent. Any known conventional material may be used as the crosslinking agent. Examples thereof include boron compounds such as boric acid and borax, glyoxal, and glutar aldehyde. One or more of these materials may be used alone or in any combination. Where two or more are used in combination, for example, the combination of boric acid and borax is preferred, and the content ratio (molar ratio) of boric acid to borax is may be from about 4:6 to about 9:1. While water such as pure water is generally used as a solvent of the crosslinking bath, the crosslinking bath may contain an organic solvent compatible with water. The concentration of the crosslinking agent in the crosslinking bath may be about 1 to about 10% by weight.

An iodide may be added to the crosslinking bath, because it can impart uniform in-plane properties to the polarizing film. Examples of the iodide include potassium iodide, lithium iodide, sodium iodide, zinc iodide, aluminum iodide, lead iodide, copper iodide, barium iodide, calcium iodide, tin iodide, and titanium iodide. The content of the iodide is preferably from 0.05 to 15% by weight, more preferably from 0.5 to 8% by weight. In particular, the combination of boric acid and potassium iodide is preferred, and the ratio (weight ratio) of boric acid to potassium iodide is preferably in the range of 1:0.1 to 1:3.5, more preferably in the range of 1:0.5 to 1:2.5. The temperature of the crosslinking bath is generally from 20 to 70° C., and the immersion time is generally from about 1 second to about 15 minutes. Similarly to the dyeing process, the crosslinking process may also use a method of applying or spraying a crosslinking agent-containing solution, or the crosslinking process may be performed simultaneously with the stretching process. In this case, the total stretch ratio may be from about 1.1 to about 3.5 times.

In the step of stretching by a wet stretching method, the film may be stretched to a total stretch ratio of about 3 to about 7 times while immersed in a treatment bath (a stretching bath). A solution prepared by adding any of various metal salts or a compound of iodine, boron or zinc to a solvent such as water, ethanol or various organic solvents is preferably used as the solution for the stretching bath. In particular, a solution containing about 2 to about 18% by weight of each of boric acid and/or potassium iodide is preferably used. Where boric acid and potassium iodide are used at the same time, the content ratio (weight ratio) of boric acid to potassium iodide is preferably from about 1:0.1 to about 1:4. The temperature of the stretching bath is preferably from about 40 to about 67° C.

In the step of washing with water, for example, the polymer film is immersed in a treatment bath (a water-washing bath) so that unnecessary residues, such as boric acid, deposited in the previous process can be washed out. An iodide may be added to the aqueous solution, and, for example, sodium iodide or potassium iodide is preferably used. The temperature of the water-washing bath may be from about 10 to about 60° C. The number of times of the water-washing process is not particularly limited. The water-washing process may be performed plural times, and it is preferred that the type and concentration of the additive in each water-washing bath be adjusted as needed.

When the polymer film is raised from each treatment bath, for the purpose of preventing dripping, a draining roll such as a known conventional pinch roll may be used or excess water may be removed by a method of scraping off the liquid with an air knife, or the like.

The drying step may use any known conventional drying method such as natural drying, blow drying, and drying by heating. For example, in the drying by heating, the heating temperature may be from about 20 to about 80° C., and the drying time may be from about 1 to about 10 minutes. In the drying step, stretching may also be performed as needed.

With respect to the polarizing film prepared through the respective steps as described above, the resulting stretch ratio (the total stretch ratio) is preferably from 3.0 to 7.0 times. If the total stretch ratio is less than 3.0, it can be difficult to obtain a polarizing film with a high degree of polarization, and if the total stretch ratio exceeds 7.0, the film can easily be broken.

The method of producing the polarizing film is not limited to the above method, and any other method may be used to produce the polarizing film. For example, the polarizing film may be produced by a dry stretching method or by kneading a polymer film material, such as polyethylene terephthalate (PET), with a dichroic material, forming the mixture into a film and stretching the film. The polarizing film may also be an O-type film comprising a uniaxially oriented liquid crystal as a host to which a dichroic dye is added as a guest (U.S. Pat. No. 5,523,863 and JP-A No. 03-503322) or an E-type film using a dichroic lyotropic liquid crystal or the like (U.S. Pat. No. 6,049,428).

The protective film aims to protect the polarizing film and thus is preferably excellent in transparency, mechanical strength, thermal stability, and isotropy. The thickness of the protective film is generally from about 1 to about 300 μm, preferably from about 5 to about 100 μm. Concerning the problems to be solved by the invention, stripe-like irregularities becomes more visible, particularly when relatively thin protective films are used. Thus, the protective film to be used preferably has a thickness of about 5 to about 60 μm, and in such a case, the effects of the invention on the polarizing plate can be remarkable. In order to improve polarization properties, durability, adhesion properties, or the like, the surface of the protective film is preferably saponified with an alkali or the like. The water-vapor permeability of such a protective film is about 0.5 to about 5000 g/m²·24 h, when it is measured at a temperature of 40° C. and a relative humidity of 90% according to JIS Z 0208 (cup method).

As materials forming the protective film, for example, polyester type polymers, such as polyethylene terephthalate and polyethylenenaphthalate; cellulose type polymers, such as diacetyl cellulose and triacetyl cellulose; acrylics type polymer, such as poly methylmethacrylate; styrene type polymers, such as polystyrene and acrylonitrile-styrene copolymer (AS resin); polycarbonate type polymer may be mentioned. Besides, as examples of the polymer forming the protective film, polyolefin type polymers, such as polyethylene, polypropylene, polyolefin that has cyclo-type or norbornene structure, ethylene-propylene copolymer; vinyl chloride type polymer; amide type polymers, such as nylon and aromatic polyamide; imide type polymers; sulfone type polymers; polyether sulfone type polymers; polyether-ether ketone type polymers; poly phenylene sulfide type polymers; vinyl alcohol type polymer; vinylidene chloride type polymers; vinyl butyral type polymers; arylate type polymers; polyoxymethylene type polymers; epoxy type polymers; or blend polymers of the above-mentioned polymers may be mentioned. The protective film may be formed as a cured layer made of heat curing type or ultraviolet ray curing type resins, such as acryl based, urethane based, acryl urethane based, epoxy based, and silicone based, etc. Particularly preferred are cellulose type polymers or polyolefin polymer films which have a cyclo-type or norbornene structure. The effect of the invention is remarkable when the triacetyl cellulose is used as the protective film.

When the protective film is bonded to both sides of the polarizing film, protective films having different properties may be used for the respective sides. Examples of such properties include thickness, material, light transmittance, tensile elasticity, and presence or absence of an optically functional layer.

The polarizing plate and at least one of a variety of optically functional layers may be laminated to form a laminate for use as an optical film. Examples of the optically functional layer include a surface treatment layer such as a hard coat layer, an antireflection layer, a sticking prevention layer, a diffusing layer, or an antiglare layer, an aligned liquid crystal layer for viewing angle compensation, optical compensation or the like. Further, one layer or two layers or more of optical layers, which may be used for formation of an image display etc., such as a polarization conversion element, a reflector, a transflective plate, a retardation plate (a half wavelength plate and a quarter wavelength plate included), and a viewing angle compensation film, brightness enhancement film, may be used. Especially preferable polarizing plates are; a reflection type polarizing plate or a transflective type polarizing plate in which a reflector or a transflective reflector is further laminated onto a polarizing plate of the present invention; an elliptically polarizing plate or a circular polarizing plate in which a retardation plate is further laminated onto the polarizing plate; a wide viewing angle polarizing plate in which a viewing angle compensation layer or a viewing angle compensation film is further laminated onto the polarizing plate; or a polarizing plate in which a brightness enhancement film is further laminated onto the polarizing plate.

When the optically functional layer is laminated, the surface treatment layer or the oriented liquid crystal layer may be generally laminated directly on a film such as a polarizing plate. However, optically functional layers of various films are preferably laminated with an adhesive layer or a pressure-sensitive adhesive layer interposed therebetween. In this case, a pressure-sensitive adhesive layer composed of a pressure-sensitive adhesive is particularly preferably used, among the adhesive and pressure-sensitive adhesive layers.

The pressure-sensitive adhesive layer may be formed of any appropriate conventional pressure-sensitive adhesive such as an acrylic, silicone, polyester, polyurethane, polyether, or rubber pressure-sensitive adhesive. The pressure-sensitive adhesive preferably form a pressure-sensitive adhesive layer with low coefficient of moisture absorption and high heat resistance, in view of prevention of a foaming or peeling phenomenon due to moisture absorption, prevention of a reduction in optical properties due to a thermal expansion difference or the like, prevention of warpage of a liquid crystal cell, and the capability to form an image display with high quality and high durability. In view of prevention of a change in the optical properties of the polarizing plate and the like, it is preferred to use a pressure-sensitive adhesive that does not require a high temperature process for curing or drying or does not require a long time for curing or drying. From these points of view, acrylic pressure-sensitive adhesives are preferably used for the polarizing plate or the optical film. File particles may also be added to the pressure-sensitive adhesive, and a pressure-sensitive adhesive layer exhibiting light diffusion properties may be formed therewith.

The adhesive layer or the pressure-sensitive adhesive layer may be provided on a necessary surface as needed. For example, concerning the polarizing plate composed of the polarizing film and the protective film as provided in the invention, the adhesive layer or the pressure-sensitive adhesive layer may be provided on one or both sides of the polarizing plate as needed, namely, it may be provided on the other surface of the protective film, which is opposite to the side bonded to the polarizing film. The post-drying thickness of the adhesive layer or the pressure-sensitive adhesive layer composed of the pressure-sensitive adhesive for use in the lamination of the optically functional layer is generally, but not limited to, from about 1 to about 500 μm, preferably from 5 to 200 μm, more preferably from 10 to 100 μm. If the adhesive layer or the pressure-sensitive adhesive layer has a thickness in the above range, the stress associated with the dimensional behavior of the polarizing plate or the optically functional layer can be relaxed.

When the pressure-sensitive adhesive layer is exposed on the surface, it is preferred that the pressure-sensitive adhesive layer is transiently covered with a separator for the purpose of antifouling or the like, until practical use. The separator preferably comprises an appropriate film, like the protective film described above, and optionally a release coating that is formed on the film and made of an appropriate release agent such as a silicone, long-chain alkyl, fluoro- or molybdenum sulfide release agent.

A hard coat processing is applied for the purpose of protecting the surface of the polarizing plate from damage, and this hard coat layer may be formed by a method in which, for example, a curable coated film with excellent hardness, slide property etc. is added on the surface of the protective film using suitable ultraviolet curable type resins, such as acrylic type and silicone type resins. Antireflection processing is applied for the purpose of antireflection of outdoor daylight on the surface of a polarizing plate and it may be prepared by forming an antireflection film according to the conventional method etc. Besides, a sticking prevention processing is applied for the purpose of adherence prevention with adjoining layer.

Antiglare processing is applied in order to prevent a disadvantage that outdoor daylight reflects on the surface of a polarizing plate to disturb visual recognition of transmitting light through the polarizing plate, and the processing may be applied, for example, by giving a fine concavo-convex structure to a surface of the protective film using, for example, a suitable method, such as rough surfacing treatment method by sandblasting or embossing and a method of combining transparent fine particle. As a fine particle combined in order to form a fine concavo-convex structure on the above-mentioned surface, transparent fine particles whose average particle size is 0.5 to 50 μm, for example, such as inorganic type fine particles that may have conductivity comprising silica, alumina, titania, zirconia, tin oxides, indium oxides, cadmium oxides, antimony oxides, etc., and organic type fine particles comprising cross-linked of non-cross-linked polymers may be used. When forming fine concavo-convex structure on the surface, the amount of fine particle used is usually about 2 to 70 weight parts to the transparent resin 100 weight parts that forms the fine concavo-convex structure on the surface. An antiglare layer may serve as a diffusion layer (viewing angle expanding function etc.) for diffusing transmitting light through the polarizing plate and expanding a viewing angle etc.

In addition, the optical layers, such as the antireflection layer, sticking prevention layer, diffusion layer, antiglare layer, etc., may be prepared directly on the polarizing plate itself, and also they may be prepared as an optical layer different from the polarizing plate.

A reflective layer is prepared on a polarizing plate to give a reflection type polarizing plate, and this type of plate is used for a liquid crystal display in which an incident light from a view side (display side) is reflected to give a display, and it has the advantage that a light source such as a backlight can be omitted so that a thin liquid crystal display can be formed. The reflection type polarizing plate may be formed by any appropriate method such as a method including forming a reflective layer made of metal or the like on one side of the polarizing plate optionally with a protective film or the like interposed therebetween.

In addition, a transflective type polarizing plate may be obtained by preparing the above-mentioned reflective layer as a transflective type reflective layer, such as a half-mirror etc. that reflects and transmits light. A transflective type polarizing plate is usually prepared in the backside of a liquid crystal cell and it may form a liquid crystal display unit of a type in which a picture is displayed by an incident light reflected from a view side (display side) when used in a comparatively well-lighted atmosphere. And this unit displays a picture, in a comparatively dark atmosphere, using embedded type light sources, such as a back light built in backside of a transflective type polarizing plate.

The above-mentioned polarizing plate may be used as elliptically polarizing plate or circularly polarizing plate on which the retardation plate is laminated. A description of the above-mentioned elliptically polarizing plate or circularly polarizing plate will be made in the following paragraph. These polarizing plates change linearly polarized light into elliptically polarized light or circularly polarized light, elliptically polarized light or circularly polarized light into linearly polarized light or change the polarization direction of linearly polarization by a function of the retardation plate. As a retardation plate that changes circularly polarized light into linearly polarized light or linearly polarized light into circularly polarized light, what is called a quarter wavelength plate (also called λ/4 plate) is used. Usually, half-wavelength plate (also called λ/2 plate) is used, when changing the polarization direction of linearly polarized light.

Elliptically polarizing plate is effectively used to give a monochrome display without above-mentioned coloring by compensating (preventing) coloring (blue or yellow color) produced by birefringence of a liquid crystal layer of a super twisted nematic (STN) type liquid crystal display. Furthermore, a polarizing plate in which three-dimensional refractive index is controlled may also preferably compensate (prevent) coloring produced when a screen of a liquid crystal display is viewed from an oblique direction. Circularly polarizing plate is effectively used, for example, when adjusting a color tone of a picture of a reflection type liquid crystal display that provides a colored picture, and it also has function of antireflection.

The retardation plate may be a known film such as a birefringent film produced by uniaxially or biaxially stretching a polymer film, an oriented film produced by orienting a liquid crystal monomer and then crosslinking and polymerizing it, a liquid crystal polymer orientation film, and a film-supported liquid crystal polymer orientation layer.

A retardation plate may be a retardation plate that has a proper retardation according to the purposes of use, such as various kinds of wavelength plates and plates aiming at compensation of coloring by birefringence of a liquid crystal layer and of visual angle, etc., and may be a retardation plate in which two or more sorts of retardation plates is laminated so that optical properties, such as retardation, may be controlled.

A viewing angle compensation film is a film for extending viewing angle so that a picture may look comparatively clearly, even when it is viewed from an oblique direction not from vertical direction to a screen. Any appropriate product for the purpose of widening the viewing angle of good visibility or preventing coloration or the like due to a retardation-induced change in viewing angle may be used. In order to achieve a wide viewing angle of good visibility, it is preferred to use a liquid crystal polymer orientation layer, particularly an optical compensation retardation plate comprising a triacetylcellulose film and an optically anisotropic layer that is composed of an obliquely oriented layer of a discotic liquid crystal polymer and supported on the triacetylcellulose film.

Examples of the polarization conversion element include an anisotropic reflective polarizer and an anisotropic scattering polarizer and specifically include PCF series produced by Nitto Denko Corporation and DBEF series produced by 3 M. A reflective grid polarizer is also preferably used as the anisotropic reflective polarizer. Examples thereof include Micro Wires produced by Moxtek Incorporated. For example, the anisotropic scattering polarizer may be DRPF produced by 3M or the like.

The polarizing plate with which a polarizing plate and a brightness enhancement film are adhered together is usually used being prepared in a backside of a liquid crystal cell. A brightness enhancement film shows a characteristic that reflects linearly polarized light with a predetermined polarization axis, or circularly polarized light with a predetermined direction, and that transmits other light, when natural light by back lights of a liquid crystal display or by reflection from a back-side etc., comes in. The polarizing plate, which is obtained by laminating a brightness enhancement film to a polarizing plate, thus does not transmit light without the predetermined polarization state and reflects it, while obtaining transmitted light with the predetermined polarization state by accepting a light from light sources, such as a backlight. This polarizing plate makes the light reflected by the brightness enhancement film further reversed through the reflective layer prepared in the backside and forces the light re-enter into the brightness enhancement film, and increases the quantity of the transmitted light through the brightness enhancement film by transmitting a part or all of the light as light with the predetermined polarization state. The polarizing plate simultaneously supplies polarized light that is difficult to be absorbed in a polarizer, and increases the quantity of the light usable for a liquid crystal picture display etc., and as a result luminosity may be improved.

Moreover, the polarizing plate of the invention may consist of multi-layered film of laminated layers of a polarizing plate and two of more of optical layers as the above-mentioned separated type polarizing plate. Therefore, a polarizing plate may be a reflection type elliptically polarizing plate or a semi-transmission type elliptically polarizing plate, etc. in which the above-mentioned reflection type polarizing plate or a transflective type polarizing plate is combined with above described retardation plate respectively.

Although an optical film with the above described optical functional layer laminated to the polarizing plate may be formed by a method in which laminating is separately carried out sequentially in producing process of a liquid crystal display etc., an optical film in a form of being laminated beforehand has an outstanding advantage that it has excellent stability in quality and assembly workability, etc., and thus producing processes ability of a liquid crystal display etc. may be raised. Proper adhesion means, such as an adhesive layer, may be used for laminating. On the occasion of adhesion of the above described polarizing plate and other optical functional layers, the optical axis may be set as a suitable configuration angle according to the target retardation characteristics etc.

In addition, ultraviolet absorbing property may be given to the above-mentioned each layer, such as a polarizing plate, a optical functional layer, an adhesive layer, and a pressure-sensitive adhesive layer, using a method of adding UV absorbents, such as salicylic acid ester type compounds, benzophenol type compounds, benzotriazol type compounds, cyano acrylate type compounds, and nickel complex salt type compounds.

The polarizing plate according to the present invention is preferably used to form an image display such as a liquid crystal display (LCD), an electroluminescence display (ELD), and a plasma display.

The polarizing plate is preferably used to form a liquid crystal display or the like. For example, the polarizing plate may be used for liquid crystal displays, such as reflective, transflective or hybrid transmissive/reflective liquid crystal displays, which comprise a liquid crystal cell and the polarizing plate placed on one side or both sides of the liquid crystal cell. The liquid crystal cell substrate may be any of a plastic substrate and a glass substrate. The liquid crystal display may use any appropriate type of liquid crystal cell such as an active matrix driving type such as a thin-film transistor type; and a simple matrix driving type such as a twisted nematic type and a super twisted nematic type.

If the polarizing plates or the optical films are placed on both sides of the liquid crystal cell, they may be the same or different. Additionally, any other appropriate component(s) such as a prism array sheet, a lens array sheet, a light diffusion plate, and a backlight may also be placed in one or more layers at an appropriate position(s) to form the liquid crystal display.

Subsequently, organic electro luminescence equipment (organic EL display) will be explained. Generally, in organic EL display, a transparent electrode, an organic emitting layer and a metal electrode are laminated on a transparent substrate in an order configuring an illuminant (organic electro luminescence illuminant). Here, an organic emitting layer is a laminated material of various organic thin films, and much compositions with various combination are known, for example, a laminated material of hole injection layer comprising triphenylamine derivatives etc., a luminescence layer comprising fluorescent organic solids, such as anthracene; a laminated material of electronic injection layer comprising such a luminescence layer and perylene derivatives, etc.; laminated material of these hole injection layers, luminescence layer, and electronic injection layer etc.

An organic EL display emits light based on a principle that positive hole and electron are injected into an organic emitting layer by impressing voltage between a transparent electrode and a metal electrode, the energy produced by recombination of these positive holes and electrons excites fluorescent substance, and subsequently light is emitted when excited fluorescent substance returns to ground state. A mechanism called recombination which takes place in a intermediate process is the same as a mechanism in common diodes, and, as is expected, there is a strong non-linear relationship between electric current and luminescence strength accompanied by rectification nature to applied voltage.

In an organic EL display, in order to take out luminescence in an organic emitting layer, at least one electrode must be transparent. The transparent electrode usually formed with transparent electric conductor, such as indium tin oxide (ITO), is used as an anode. On the other hand, in order to make electronic injection easier and to increase luminescence efficiency, it is important that a substance with small work function is used for cathode, and metal electrodes, such as Mg—Ag and Al—Li, are usually used.

In organic EL display of such a configuration, an organic emitting layer is formed by a very thin film about 10 nm in thickness. For this reason, light is transmitted nearly completely through organic emitting layer as through transparent electrode. Consequently, since the light that enters, when light is not emitted, as incident light from a surface of a transparent substrate and is transmitted through a transparent electrode and an organic emitting layer and then is reflected by a metal electrode, appears in front surface side of the transparent substrate again, a display side of the organic EL display looks like mirror if viewed from outside.

In an organic EL display containing an organic EL illuminant equipped with a transparent electrode on a surface side of an organic emitting layer that emits light by impression of voltage, and at the same time equipped with a metal electrode on a back side of organic emitting layer, a retardation plate may be installed between these transparent electrodes and a polarizing plate, while preparing the polarizing plate on the surface side of the transparent electrode.

Since the retardation plate and the polarizing plate have function polarizing the light that has entered as incident light from outside and has been reflected by the metal electrode, they have an effect of making the mirror surface of metal electrode not visible from outside by the polarization action. If a retardation plate is configured with a quarter wavelength plate and the angle between the two polarization directions of the polarizing plate and the retardation plate is adjusted to π/4, the mirror surface of the metal electrode may be completely covered.

### EXAMPLES

The invention is more specifically described with the examples and comparative examples below, which are not intended to limit the scope of the invention.

### Example 1

### Preparation of Polarizing Film

A 50 μm-thick polyvinyl alcohol (PVA) film (M-5000, produced by Nippon Synthetic Chemical Industry Co., Ltd.) was stretched to a stretch ratio of 2.5 while immersed in pure water at 30° C. for 60 seconds, then dyed in an aqueous iodine solution (pure water/iodine (I)/potassium iodide (KI)=100/0.01/1 in weight ratio) at 30° C. for 45 seconds, then immersed in an aqueous 3% by weight boric acid solution for 30 seconds, then stretched to a stretch ratio of 5.8 in an aqueous 4% by weight boric acid solution, then immersed in an aqueous 5% by weight KI solution for 10 seconds, and then dried at 60° C. for 3 minutes while the tension of the film was maintained, so that a polarizing film was obtained. The polarizing film had a thickness of 19 μm and a moisture percentage of 23.2%.

### (Preparation of Adhesive)

A hundred parts by weight of PVA resin (Gosenol, produced by Nippon Synthetic Chemical Industry Co., Ltd.) and 35 parts by weight of a crosslinking agent (Watersol, produced by Dainippon Ink and Chemicals, Incorporated) were dissolved in 3760 parts by weight of pure water to form an adhesive.

### (Preparation of Polarizing Plate)

A 40 μm-thick triacetylcellulose (TAC) film (UZ-40T, produced by Fujifilm Corporation) was bonded to both sides of the resulting polarizing film with the adhesive prepared as described above. In the bonding process, pressing from upper and lower sides was performed using first and second rolls, in which the first roll was an iron roll with a diameter of 100 mm, and the second roll was a rubber roll with a diameter of 100 mm composed of an iron core and a rubber layer (65 degrees in hardness, 3.5 mm in thickness) placed around the core. In this process, the lamination pressure at the bonded portion was 0.38 MPa, and the convey rate was 5.8 m/minute. The laminate was then dried at 60° C. for 3 minutes to give a polarizing plate. After the drying process, the adhesive layer of the polarizing plate had a thickness of 22 nm.

### Example 2

A polarizing film was prepared under the same conditions as those in Example 1 (Preparation of Polarizing Film), except that a 75 μm-thick PVA film (2400 in degree of polymerization, produced by Kuraray Co., Ltd.) was used instead. The resulting polarizing film had a thickness of 27 μm and a post-drying moisture percentage of 24.8%. An 80 μm-thick TAC film (UZ-80T, produced by Fujifilm Corporation) was bonded to both sides of the polarizing film in the same manner as Example 1 to form a polarizing plate. After the drying process, the adhesive layer of the polarizing plate had a thickness of 31 μm.

### Example 3

A polarizing film with a thickness of 19 μm and a post-drying moisture percentage of 26.7% was obtained using the process of Example 1 (Preparation of Polarizing Film), except that in the drying process, the film was dried at 25° C. for 1.5 minutes while the tension of the film was maintained. A TAC film, the same as in Example 1, was bonded to both sides of the polarizing film, and a polarizing plate was prepared similarly to Example 1. In the bonding process, the first roll used was an iron roll with a diameter of 200 mm, and the second roll used was a rubber roll with a diameter of 200 mm composed of an iron core and a rubber layer (80 degrees in hardness, 7 mm in thickness) placed around the core. In this process, the lamination pressure at the bonded portion was 0.42 MPa, and the convey rate was 5.8 m/minute. After the drying process, the adhesive layer of the polarizing plate had a thickness of 49 mm.

### Example 4

A polarizing film with a thickness of 27 μm and a post-drying moisture percentage of 19.8% was obtained using the process of Example 1 (Preparation of Polarizing Film), except that a 75 μm-thick PVA film (2400 in degree of polymerization, produced by Kuraray Co., Ltd.) was used instead and that the film was dried at 60° C. for 5 minutes. A TAC film, the same as in Example 1, was bonded to both sides of the polarizing film similarly to Example 1 to form a polarizing plate. In the bonding process, the first roll used was an iron roll with a diameter of 200 mm, and the second roll used was a rubber roll with a diameter of 200 mm composed of an iron core and a rubber layer (65 degrees in hardness, 7 mm in thickness) placed around the core. In this process, the lamination pressure at the bonded portion was 0.26 MPa, and the convey rate was 5.8 m/minute. After the drying process, the adhesive layer of the polarizing plate had a thickness of 49 nm.

### Example 5

A polarizing film with a thickness of 19 μm and a post-drying moisture percentage of 14.6% was obtained using the process of Example 1 (Preparation of Polarizing Film), except that the film was dried at 80° C. for 4.5 minutes while air flowing was performed. A TAC film, the same as in Example 1, was bonded to both sides of the polarizing film similarly to Example 1 to form a polarizing plate. In the bonding process, the first roll used was an iron roll with a diameter of 200 mm, and the second roll used was a rubber roll with a diameter of 200 mm composed of an iron core and a rubber layer (65 degrees in hardness, 7 mm in thickness) placed around the core. In this process, the lamination pressure at the bonded portion was 0.26 MPa, and the convey rate was 5.8 m/minute. After the drying process, the adhesive layer of the polarizing plate had a thickness of 51 nm.

### Comparative Example 1

A polarizing film with a thickness of 19 μm and a post-drying moisture percentage of 26.9% was obtained using the process of Example 1 (Preparation of Polarizing Film), except that in the drying process, the film was dried at 25° C. for 1 minute while the tension of the film was maintained. A TAC film, the same as in Example 1, was bonded to both sides of the polarizing film similarly to Example 1 to form a polarizing plate. In the bonding process, both of the first and second rolls used were a rubber roll with a diameter of 200 mm composed of an iron core and a rubber layer (80 degrees in hardness, 7 mm in thickness) placed around the core. In this process, the lamination pressure at the bonded portion was 0.28 MPa, and the convey rate was 5.8 m/minute. After the drying process, the adhesive layer of the polarizing plate had a thickness of 54 nm.

### Comparative Example 2

A polarizing film with a thickness of 19 μm and a post-drying moisture percentage of 28.3% was obtained using the process of Example 1 (Preparation of Polarizing Film), except that in the drying process, the film was dried at 25° C. for 1.5 minutes while the tension of the film was maintained. A TAC film, the same as in Example 1, was bonded to both sides of the polarizing film similarly to Example 1 to form a polarizing plate. In the bonding process, the first roll used was an iron roll with a diameter of 200 mm, and the second roll used was a rubber roll with a diameter of 200 mm composed of a rubber core and a rubber layer (65 degrees in hardness, 7 mm in thickness) placed around the core. In this process, the lamination pressure at the bonded portion was 0.26 MPa, and the convey rate was 8.7 m/minute. After the drying process, the adhesive layer of the polarizing plate had a thickness of 78 nm.

The polarizing plates prepared in the examples and the comparative examples were evaluated by the methods below.

### (Method for Measuring Adhesive Layer Thickness)

The thickness was measured using a photograph of a cross section obtained by FE-TEM (Field Emission Transmission Electron Microscope) measurement.

### (Method for Measuring Moisture Percentage of Polarizing Film)

A 180 mm×500 mm sample was cut from the resulting polarizing film, and its initial weight (W (g)) was measured. The sample was allowed to stand in a drying machine at 120° C. for 2 hours and then measured for post-drying weight (D (g)). These measured values were used to calculate a moisture percentage according to the following formula: moisture percentage

(%)={(W−D)/W}×100

### (Method for Evaluation of Polarizing Plate Appearance)

A 50 mm×60 mm sample was cut from the resulting polarizing plate and fixed in a flat position. A piece of black paper larger in area than the sample was placed under the sample. Under fluorescent lighting, the sample was placed such that its surface reflected light. The sample surface reflection of the fluorescent lighting was visually evaluated in a position close to the surface level. The criteria for the evaluation were as follows:

◯: there are no visible minute stripe-like irregularities on the surface of the polarizing plate;
Δ: there are visible minute stripe-like irregularities on the surface of the polarizing plate; and
x: there are visible significant stripe-like irregularities on the surface of the polarizing plate.

### (Magnitude of Variations in Irregularities of Polarizing Plate Surface (Gradient))

Date on the distribution of irregularities were obtained using a contact type surface roughness meter (P-11, produced by Tenor-Instruments) with respect to the stripe-like irregularities of the surface of the polarizing plate. The measurement conditions were as follows: needle pressure 8 mg, scanning speed 0.4 mm/second, frequency 50 Hz, scanning length 30 mm, Cut-Off 0.28-1.4 mm. The data on the distribution of irregularities were Fourier analyzed so that a period and an amplitude fit for the irregularities were obtained. From the result, the magnitude of variations in the irregularities (gradient) was calculated. The smaller the magnitude of variations in the irregularities (gradient), the stripe-like irregularities is evaluated as smaller.

Concerning the examples and the comparative examples above, Table 1 provides a summary of the production conditions (the first and second rolls and the lamination pressure), the thickness and moisture percentage of the polarizing films at the time of the protective film lamination, the thickness of the adhesive layers of the polarizing plates after drying, and the evaluation of the polarizing plate appearance (stripe-like irregularities) and the magnitude of variations in irregularities (gradient).

| | First Roll | | | Second Roll | | | |
|---|---|---|---|---|---|---|---|
| | | | Rubber | | | Rubber | |
| | | | Layer | | | Layer | Lamination |
| | Diameter | Hardness | Thickness | Diameter | | Thickness | Pressure |
| | mm | degrees | mm | mm | Hardness | mm | MPa |
| Example 1 | 100 | Iron | — | 100 | 65 | 3.5 | 0.38 |
| Example 2 | 100 | Iron | — | 100 | 65 | 3.5 | 0.38 |
| Example 3 | 200 | Iron | — | 200 | 80 | 7 | 0.42 |
| Example 4 | 200 | Iron | — | 200 | 65 | 7 | 0.26 |
| Example 5 | 200 | Iron | — | 200 | 65 | 7 | 0.26 |
| Comparative | 200 | 80 | 7 | 200 | 80 | 7 | 0.28 |
| Example 1 | | | | | | | |
| Comparative | 200 | Iron | — | 200 | 65 | 7 | 0.26 |
| Example 2 | | | | | | | |

| | Polarizer | | | Evaluation of | |
|---|---|---|---|---|---|
| | | Moisture | Adhesive Layer | Irregularities | Gradient of |
| | Thickness | Percentage | Thickness | Visual | Irregularities |
| | μm | % | nm | Observation | — |
| Example 1 | 19 | 23.2 | 22 | ◯ | 0.00754 |
| Example 2 | 27 | 24.8 | 31 | ◯ | 0.01290 |
| Example 3 | 19 | 26.7 | 49 | Δ | 0.00939 |
| Example 4 | 27 | 19.8 | 49 | ◯ | 0.01639 |
| Example 5 | 19 | 14.6 | 51 | Δ | 0.01924 |
| Comparative | 19 | 26.9 | 54 | X | 0.06260 |
| Example 1 | | | | | |
| Comparative | 19 | 28.3 | 78 | X | 0.11000 |
| Example 2 | | | | | |

As is evident from the results shown in Table 1, if the thickness of the adhesive layer is 52 nm or less, the stripe-like irregularities of the surface of the polarizing plate become less visible, while if it is more than 52 nm, the stripe-like irregularities become more visible. It is also apparent that if the moisture percentage of the polarizing film is in the range of 15 to 26% by weight at the time of the protective film lamination, the in-plane uniformity evaluated by visual examination for the stripe-like irregularities are particularly good.

### INDUSTRIAL APPLICABILITY

The polarizing plate of the invention and the optical film including the polarizing plate are suitable for use in image displays such as liquid crystal displays (LCDs) and electroluminescence displays (ELDs).

1. A polarizing plate, comprising:
a polarizing film; and a protective film bonded to one or both sides of the polarizing film with an adhesive layer or a pressure-sensitive adhesive layer interposed therebetween, wherein the adhesive layer or the pressure-sensitive adhesive layer has a thickness of 52 nm or less.

2. The polarizing plate according to claim 1, wherein the polarizing film has a moisture percentage of 15 to 26% by weight when the protective film is bonded to one or both sides of the polarizing film with the adhesive layer or the pressure-sensitive adhesive layer interposed therebetween.

3. The polarizing plate according to claim 1, wherein the polarizing film has a thickness of 5 to 40 μm.

4. A method for producing a polarizing plate, comprising:
bonding a protective film to one or both sides of a polarizing film with an adhesive or a pressure-sensitive adhesive; and
then drying them by heating, wherein
the adhesive or the pressure-sensitive adhesive is laminated such that an adhesive layer or a pressure-sensitive adhesive layer having a thickness of 52 nm or less is formed after the drying.

5. The method according to claim 4, wherein the polarizing film has a controlled moisture percentage of 15 to 26% by weight when the protective film is bonded to one or both sides of the polarizing film with the adhesive or the pressure-sensitive adhesive.

6. The method according to claim 4, wherein the polarizing film has a thickness of 5 to 40 μm.

7. The method according to claim 4, wherein the bonding is conducted to apply the adhesive or the pressure-sensitive adhesive between the polarizing film and the protective film interposed and compress to pass them between a pair of a first roll and a second roll.

8. The method according to claim 7, wherein the first roll is a metal roll, and the second roll is an elastic roll comprising a metallic core coated with a rubber layer or a resin layer.

9. The method according to claim 8, wherein the first roll is an iron roll.

10. The method according to claim 8, wherein the rubber layer or the resin layer of the second roll has a hardness of 60 to 90.

11. The method according to claim 7, wherein the first and second rolls each have a roll diameter of 30 mm to 250 mm.

12. The method according to claim 4, wherein the protected film is bonded to one or both sides of the polarizing film with a dry lamination adhesive.

13. A polarizing plate, produced by the method according to claim 4.

14. An optical film, comprising:
the polarizing plate according to claim 1; and
at least one optically functional layer laminated on the polarizing plate.

15. An image display, comprising the polarizing plate according to claim 1.

16. An image display, comprising the polarizing plate according to the optical film according to claim 14.
